(19) United States
(12) Patent Application Publication
(10) Pub. No.: US 2025/0392641 A1
(43) Pub. Date: Dec. 25, 2025

(54) DATA CONFIGURATION METHOD, APPARATUS, STORAGE MEDIUM, AND ELECTRONIC DEVICE

(71) Applicant: Lenovo (Beijing) Limited, Beijing (CN)

(72) Inventors: Lei LI, Beijing (CN); Min JI, Beijing (CN); Bing LIU, Beijing (CN)

(21) Appl. No.: 19/245,880

(22) Filed: Jun. 23, 2025

(30) Foreign Application Priority Data
Jun. 25, 2024 (CN) 202410832389.X

(51) Int. Cl. H04L 67/1097

(52) U.S. Cl. CPC H04L 67/1097

(57) ABSTRACT

A data configuration method includes monitoring a target segment of a virtual network interface card (VF) capable of implementing a remote direct memory access (RDMA) communication mode, and in response to detecting a change event in the target segment of the VF, synchronizing configuration data of a namespace represented by the target segment to configuration information of a container resource in a first communication mode and a second communication mode. The target segment is set in a configuration space of the VF and is used to represent identification information of an independent namespace assigned to the VF in a container.

### CROSS-REFERENCE TO RELATED APPLICATION

The present disclosure claims priority to Chinese Patent Application No. 202410832389.X, filed on Jun. 25, 2024, the entire content of which is incorporated herein by reference.

### TECHNICAL FIELD

The present disclosure relates to the data processing technology field and, more particularly, to a data configuration method, a data configuration apparatus, a storage medium, and an electronic device.

### BACKGROUND

As centralized storage, distributed storage, and cloud databases are widely used, more and more data needs to be obtained from networks for application services, which imposes higher and higher requirements on an exchange speed and performance of the networks. For example, in an AI (artificial intelligence) distributed training scenario, each workload generally runs in a container on each node. The nodes communicate through an RDMA (Remote Direct Memory Access) to meet requirements for high bandwidth and low delay of AI distributed training tasks.

If data transmission is required through an RDMA communication, the relevant configuration needs to be performed on the RDMA. How to accurately configure the RDMA to ensure the normal application of a corresponding container becomes a problem that needs to be solved.

### SUMMARY

An aspect of the present disclosure provides a data configuration method. The method includes monitoring a target segment of a virtual network interface card (VF) capable of implementing a remote direct memory access (RDMA) communication mode, and in response to detecting a change event in the target segment of the VF, synchronizing configuration data of a namespace represented by the target segment to configuration information of a container resource in a first communication mode and a second communication mode. The target segment is set in a configuration space of the VF and is used to represent identification information of an independent namespace assigned to the VF in a container.

An aspect of the present disclosure provides a data configuration apparatus, including a monitoring unit and a synchronization unit. The monitoring unit is configured to monitor a target segment of a virtual network interface card (VF) capable of implementing a remote direct memory access (RDMA) communication mode. The synchronization unit is configured to, in response to detecting a change event in the target segment of the VF, synchronize configuration data of a namespace represented by the target segment to configuration information of a container resource in a first communication mode and a second communication mode. The target segment is set in a configuration space of the VF and is used to represent identification information of an independent namespace assigned to the VF in a container.

An aspect of the present disclosure provides an electronic device, including one or more processors and one or more memories. The one or more memories store an application and data generated by the application during operation that, when executed by the one or more processors, cause the one or more processors to monitor a target segment of a virtual network interface card (VF) capable of implementing a remote direct memory access (RDMA) communication mode, and in response to detecting a change event in the target segment of the VF, synchronize configuration data of a namespace represented by the target segment to configuration information of a container resource in a first communication mode and a second communication mode. The target segment is set in a configuration space of the VF and is used to represent identification information of an independent namespace assigned to the VF in a container.

### BRIEF DESCRIPTION OF THE DRAWINGS

FIG. 1 illustrates a schematic flowchart of a data configuration method according to some embodiments of the present disclosure.

FIG. 2 illustrates a schematic diagram showing an application scenario for AI distributed training according to some embodiments of the present disclosure.

FIG. 3 illustrates a schematic flowchart of a synchronous configuration according to some embodiments of the present disclosure.

FIG. 4 illustrates a schematic structural diagram of a data configuration apparatus according to some embodiments of the present disclosure.

### DETAILED DESCRIPTION OF THE EMBODIMENTS

The technical solutions of embodiments of the present disclosure are described in detail in connection with the accompanying drawings of embodiments of the present disclosure. Apparently, the embodiments described are only some embodiments of the present disclosure, and not all embodiments. Based on embodiments of the present disclosure, all other embodiments obtained by those skilled in the art without creative effort shall fall within the scope of the present disclosure.

The terms “first” and “second” in the present disclosure are used to distinguish different objects and are not intended to describe a specific order. In addition, the terms “including,” “having,” and any variations thereof are intended to cover non-exclusive inclusion. For example, a process, method, system, product, or device that includes a series of steps or units is not limited to the listed steps or units but may include steps or units not explicitly listed.

Embodiments of the present disclosure provide a data configuration method, which is applied to the field of virtual machine containers. By synchronizing configuration data of a naming space of a virtual network interface card (NIC) into configuration information of container resources under different communication modes, the problem of inconsistent namespace configurations for the namespace of the NICs corresponding to different communication modes when the container uses the NIC, ensuring the normal application of the container resources.

To facilitate the description of the data configuration method of embodiments of the present disclosure, the relevant terms used in the present disclosure are explained below.

Kubernetes, abbreviated as K8s, eight characters “ubernete” in the middle of the name are replaced with the number 8. Kubernetes is an open-source platform for managing containerized applications on a plurality of hosts in a cloud platform. The goal of Kubernetes includes making deploying the containerized applications simple and highly efficient. Kubernetes can provide mechanisms for application deployment, plan, update, and maintenance. Kubernetes can realize the application deployment on the cloud platform by establishing containers. Each container can be isolated from other containers. Each container can have its own file system. The progress may not be mutually affected between the containers, and the computation resources can be distinguished. Compared to a virtual machine, the container can be deployed quickly.

Kubernetes is a container-based cluster management platform used to manage the containerized applications on a plurality of hosts within the platform. A container can be configured to carry a software program. Correspondingly, a Pod is a basic operational unit in Kubernetes and a smallest establish-able, debug-able, and manageable deployment unit. A plurality of containers within a same Pod can share network resources (e.g., IP addresses), and one or more containers can be packaged in each Pod.

A namespace can be configured to achieve network isolation. The namespace can be used to divide the use of network devices, addresses, ports, routes, firewall rules, etc., into different boxes to virtualize the network within a single running kernel example. Additionally, the plurality of objects within the same namespace can share network resources. For example, the plurality of containers deployed in the same Pod can be arranged in the same namespace to allow the plurality of containers in the same Pod to share the network resources.

An RDMA (Remote Direct Memory Access) is a network communication without involving operating systems of two communicating parties and with a high throughput and low delay, which is widely used in various scenarios.

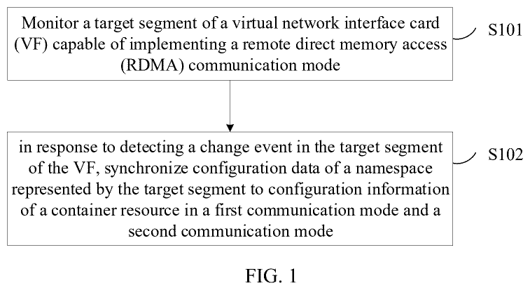

FIG. 1 illustrates a schematic flowchart of a data configuration method according to some embodiments of the present disclosure. The method includes the following steps.

At S101, a target segment of the NIC capable of realizing the RDMA communication mode is monitored.

When a container is created on a host, the NIC corresponding to the container can be generated based on the physical NIC of the host. In embodiments of the present disclosure, the NIC can support the RDMA communication mode. In a PCI configuration space of the NIC supporting the RDMA feature, a target segment can be added for each NIC. The target segment can be used to represent the identification information of the independent namespace assigned to the NIC in the container. Specific information about the namespace assigned to the NIC in the container can be obtained through the target segment. For example, when the target segment is 1, the independent namespace corresponding to the target segment can be Namespace1. By monitoring the target segment, whether the independent namespace assigned to the NIC in the container changes can be obtained. For example, an independent namespace can be newly added, a previous independent namespace can be deleted, or the namespace can be adjusted.

At S102, when the target segment of the NIC is detected to change, the configuration data of the namespace represented by the target segment is synchronized to the configuration information of the container resources in the first communication mode and the second communication mode.

During monitoring the target segment, if the change event of the target segment is detected, the synchronous processing may need to be performed in different communication modes. The change event of the target segment can include that the identification information of the namespace represented by the current target segment is different from the identification information of the namespace of the last monitoring cycle, or the current identification information of the namespace represented by the target segment is different from the initial identification information controlled by naming. After detecting the change event of the target segment, the configuration data of the namespace represented by the target segment can be synchronized to the configuration information of the container resource in the first communication mode and the second communication mode. The first communication mode and the second communication mode can be two different communication modes. For example, the first communication mode can be an Ethernet communication mode, and the second communication mode can be an RDMA communication mode. The configuration data of the independent namespace of the NIC can be synchronized for the two communication modes. Thus, the container can use the NIC.

For example, when an application based on the RDMA is deployed on a virtualization platform such as k8s, the platform can initiate a network namespace corresponding to the container to launch the RDMA application. The RDMA network interface card (NIC) can generate a corresponding virtual function (VF) by using the RDMA physical function (PF) on the physical server to virtualize the RDMA network interface card (NIC). However, a kernel stack and an RDMA software stack can generate an Ethernet and an RDMA network, respectively, when the VF is processed. Thus, when the container uses the VF, namespaces can be set for the Ethernet and the RDMA, respectively. By monitoring the target segment of the VF, after the change event of the target segment is detected, the configuration data of the namespace represented by the target segment can be synchronized to the configuration information of the container resources in the two network communication modes. Thus, the issues such as missing configurations or inconsistent configurations when the namespace is configured can be solved to allow the container resources to be called.

In embodiments of the present disclosure, to facilitate the synchronization of configuration information of the namespace, the target segment can be pre-configured to monitor of the target segment and information synchronization can be performed when the change event is detected. In some embodiments, the PF and the VF configured at the host can be configured to set the target segment of the VF when the PF is determined to support the RDMA and set the initial values. In some embodiments, when the PF supports the RDMA, the NIC generated based on the PF can also support the RDMA. Then, while the VF is generated, the corresponding target segment can also be set to facilitate monitoring the identification information of the namespace subsequently. In some embodiments, the when the software uses the VF in the configuration container, the software can directly call the network interface card (NIC) driver to configure the target segment in the configuration space of the VF. For example, when segment nsid is used to represent the target segment, the initial value can be 0. Since only when the PF supports the RDMA, the target segment can be configured in the corresponding VF. Thus, by detecting whether the configuration information of the VF includes the target segment, whether the VF supports the RDMA can be determined. Then, the detection process of the software when the VF of the container is configured can be ignored. That is, whether the VF supports the RDMA may not be necessarily detected, and whether the system is installed with a software stack related to the RDMA may not be necessarily detected. Thus, the efficiency of the data application can be improved.

Further, the method can further include, when the target container application assigns a VF to the container, obtaining the configuration information of the independent namespace corresponding to the container, and based on the configuration information of the independent namespace, modifying the initial value of the target segment of the VF to the current value.

In a PCI (Peripheral Component Interconnect) configuration space of a network interface card (NIC) supporting the RDMA, a target segment can be added to each VF. When the PF is initialized to generate the VF, the target segments (e.g., represented as nsid) of the VFs can have an initial value of 0. When the kernel protocol stack and the RDMA protocol stack are used to initialize the VF to generate the corresponding Ethenet network structure (represented as net_device) and the RDMA network structure (represented as ibv_device), the initialization process can follow the standard procedure. During the initialization, the network namespaces of the VFs can be set to 0. When the target container application (e.g., K8s and the corresponding container network interface (CNI)) assigns a VF to a container, if the container uses its own independent network namespace, the container network interface (CNI) can call the network driver to set the target segment (e.g., nsid) of the VF PCI configuration space as the current value. That is, the target segment (e.g., nsid) can be set as the identification information (e.g., namespace id) of the namespace of the container.

Correspondingly, detecting the change event of the target segment of the VF can include that the initial value of the target segment of the VF is changed to the current value. Then, the method can further include if the namespace corresponding to the container is detected to have changed, updating the configuration information of the independent namespace, based on the updated configuration information of the independent namespace, updating the current value of the target segment of the VF, and based on the updated current value of the target segment, updating the target segment.

During application, to isolate different types of resources, different types of namespaces can be provided in the Linux kernel, such as a process namespace, a network namespace, a mount namespace, and a user namespace. Taking the network namespace as an example, this namespace can be used to isolate network resources, including network interfaces, IP addresses, and routing tables. Each container typically can have its own network namespace, allowing the container to run the network stack of the container in isolation from other containers. If the isolated resources corresponding to the namespace are detected to change, or the related information included in the isolated resources is changed, the namespace can be determined to have changed. Correspondingly, the configuration information of the independent namespace can be updated. If the updated configuration information affects the value corresponding to the target segment, the current value of the target segment of the VF can be updated synchronously.

When the first communication mode includes the Ethernet communication mode, and the second communication mode includes the RDMA communication mode, synchronizing the configuration data of the namespace represented by the target segment to the configuration information of the container resources in the first communication mode and the second communication modes can include synchronizing the configuration data of the namespace represented by the target segment to the kernel protocol stack corresponding to the Ethernet communication mode and the RDMA protocol stack corresponding to the RDMA communication mode. The container application platform can perform data transmission in the Ethernet communication mode based on the configuration information of the kernel protocol stack, and perform data transmission in the RDMA communication mode based on the configuration information of the RDMA protocol stack.

Further, the method can further include, if the container application platform generates a resource calling request, parsing the resource calling request to determine the target communication mode corresponding to the resource calling request, obtaining the target container resource information corresponding to the target communication mode based on the independent namespace corresponding to the target communication mode, and responding to the resource calling request based on the target container resource information.

The container application platform can be container application software, such as an AI (Artificial Intelligence) application. When the container application platform generates a resource calling request, parsing needs to be performed to obtain the data transmission communication mode corresponding to the resource calling request. If the RDMA communication mode is used, this communication mode can be determined as the target communication mode, and the namespace corresponding to the target communication mode can be obtained, e.g., the network namespace. According to the network interfaces and IP addresses included in the network namespace, the communicative connection can be established in the RDMA communication mode to obtain the container resource information corresponding to the container.

In some embodiments, by monitoring the target segment and synchronizing the configuration information, the configuration information of the namespace represented by the target segment of the network interface card (NIC) PCI configuration space can be synchronized to the kernel protocol stack and the RDMA protocol stack in real time. The issue of missing configuration or non-matching configurations of the namespace and the kernel protocol stack and the RDMA protocol stack may not appear. Thus, the convenience and accuracy of the container resource application can be improved.

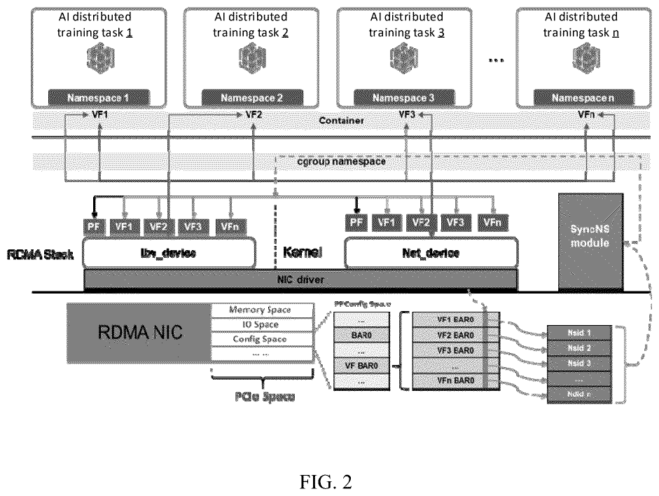

By taking the application scenario of AI (Artificial Intelligence) distributed training as an example, the data configuration method of embodiments of the present disclosure can be described. As shown in FIG. 2, in the AI distributed training scenario, workloads are running the the containers of the nodes. The nodes can perform high-performance RDMA communication by using the RDMA VFs to meet the high-bandwidth, low-latency requirements of AI distributed training tasks. When a container needs to use a VF, the namespace of net_device (Ethernet network) and ibv_device (RDMA network) may need to be configured, and the configurations of the namespaces of net_device (Ethernet network) and ibv_device (RDMA network) may need to be consistent.

In FIG. 2, the AI distributed training task includes n tasks. Each task is running in containers on various nodes. When a container needs to use a VF, the container can use the VF through the namespace corresponding to the VF. In some embodiments, different tasks correspond to different VFs and different namespaces. For example, AI distributed training task 1 corresponds to VF1 with namespace Namespace1, AI distributed training task 2 corresponds to VF2 with namespace Namespace2, AI distributed training task 3 corresponds to VF3, with namespace Namespace3, and AI distributed training task n corresponds to VFn with namespace Namespace n. Each VF can have a corresponding target segment. The target segment can represent the identification information of the namespace. The target segment is represented by Nsid in FIG. 2. For example, VF1 corresponds to target segment Nsid1, and VFn corresponds to target segment Nsidn.

By adding a synchronization module (SyncNS module in FIG. 2) on the host, the synchronization module detects a change event in the segment nsid in the VF configuration space. When a change occurs, the Nsid value can be synchronized to the Ibv_device structure and Net_device structure. Then, from the kernel protocol stack and RDMA protocol stack, the VF device is transferred into the namespace of the container. The Net_device structure can be a structure storing the network device information in the Linux kernel protocol stack. The Ibv_device structure can be a RDMA-related software stack (i.e., RDMA stack).

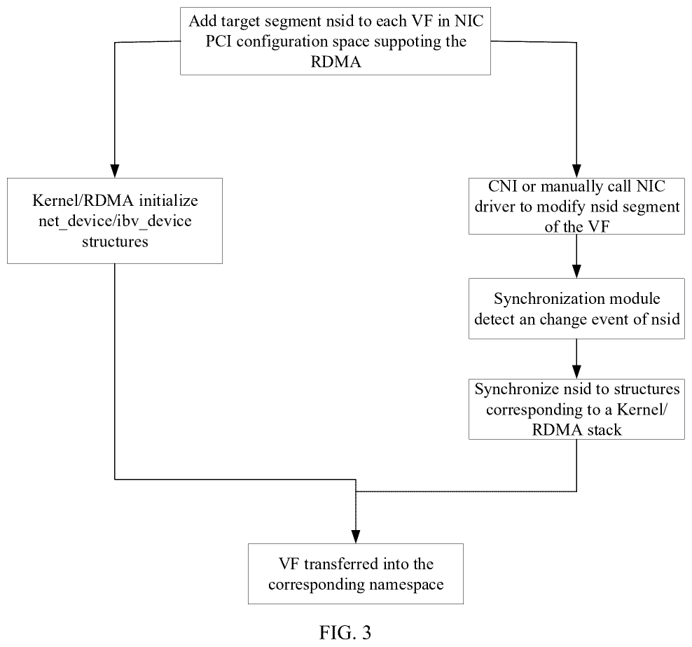

In some embodiments, FIG. 3 illustrates a schematic flowchart of a synchronous configuration according to some embodiments of the present disclosure.

In the network PCI configuration space supporting the RDMA, the target segment nsid is added to each VF. When the PF is initialized to generate the VF, the nsid initial values of the VFs are set to 0.

When the kernel protocol stack and the RDMA protocol stack initialize the VF to generate the corresponding structure, e.g., net_device/ibv_device, the initialization can be performed according to a standard procedure. During the initialization, the network namespaces of the VFs can be 0.

When the software (e.g., K8s and the corresponding CNI) assigns a VF to a container, if the container uses its own independent network namespace, the CNI can call the NIC driver to set the nsid of the VF PCI configuration space as the namespace id of he container.

The SyncNS module can be newly added to the host. The module can be configured to monitor the change event of the segment nsid in the VF PCI configuration space. When the change event is detected, the nsid can be synchronized to the ibv_device structure and the net_device structure. Thus, from the kernel protocol stack and the RDMA protocol stack, the VF device can be transferred into the namespace of the container.

In the application scenario embodiments, in the network interface card (NIC) PCI configuration space supporting the RDMA, the nsid segment (i.e., the identification segment of the namespace) can be added to each VF. When the software uses the VF in the configuration container, the network driver can be directly called to configure the segment nsid in the VF configuration space. The synchronization module can be added to the host to monitor the event notification of the PCI configuration space and synchronize the nsid of the PCI configuration space when the nsid changes to the configurations of the net_device/ibv_device structures. In this solution, the detection process of the software during configuring the container VF can be saved, whether the network interface card (NIC) supports the RDMA and whether the system is installed with the RDMA-related software stack may not need to be detected. Through the synchronization module, the nsid segment of the network interface card (NIC) PCI configuration space can be synchronized to the kernel protocol stack and the RDMA protocol stack in real-time without missing the configuration or mismatching configurations on the NIC PCI configuration space v.s. the kernel protocol stack and the RDMA protocol stack.

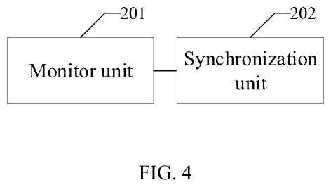

FIG. 4 illustrates a schematic structural diagram of a data configuration apparatus according to some embodiments of the present disclosure. The apparatus includes a monitoring unit 201 and a synchronization unit 202.

The monitoring unit 201 can be configured to monitor a target segment of a VF capable of implementing the RDMA communication mode.

The synchronization unit 202 can be configured to, upon detecting a change event in the target segment of the virtual network interface card, synchronize the configuration data of the namespace represented by the target segment to the configuration information of container resources in the first communication mode and the second communication mode.

Here, the target field can be set in the configuration space of the VF and can be used to represent the identification information of the VF in the independent namespace assigned to the container.

In some embodiments, the apparatus can further include a setting unit. The setting unit can be configured to configure the VF based on the PF of the host, set the target segment of the VF when the PF is determined to support the RDMA, and set the initial value of the target segment.

In some embodiments, the apparatus can further include a first acquisition unit and a modification unit.

The first acquisition unit can be configured to obtain the configuration information of the independent namespace corresponding to the container when the target container application assigns the VF card to the container.

The modification unit can be configured to modify the initial value of the target segment of the VF to the current value based on the configuration information of the independent namespace.

In some embodiments, the change event of the target segment of the VF can include that the initial value of the target segment is changed to the current value.

The apparatus can further include a first update unit, a second update unit, and a third update unit.

The first update unit can be configured to update the configuration information of the independent namespace if a change in the namespace corresponding to the container is detected.

The second update unit can be configured to update the current value of the target segment of the VF based on the updated configuration information of the independent namespace.

The third update unit can be configured to update the target segment based on the updated current value of the target segment.

In some embodiments, the first communication mode can include the Ethernet communication mode, and the second communication mode can include the RDMA communication mode. The synchronization unit can be configured to synchronize the configuration data of the namespace represented by the target segment to the kernel protocol stack corresponding to the Ethernet communication mode and the RDMA protocol stack corresponding to the RDMA communication mode. The container application platform can perform data transmission in the Ethernet communication mode based on the configuration information of the kernel protocol stack. The container application platform can perform the data transmission in the RDMA communication mode based on the configuration information in the RDMA protocol stack.

In some embodiments, the apparatus can further include a parsing unit, a second acquisition unit, and a response unit.

The parsing unit can be configured to parse the resource calling request if the container application platform generates the resource calling request, and determine the target communication mode corresponding to the resource calling request.

The second acquisition unit can be configured to obtain the target container resource information corresponding to the target communication mode based on the independent namespace corresponding to the target communication mode.

The response unit can be configured to respond to the resource calling request based on the target container resource information.

For the implementation of the units and sub-units of embodiments of the present disclosure, reference can be made to the above description, which is not repeated here.

In some other embodiments of the present disclosure, a storage medium is provided. The storage medium stores a computer program that, when executed by a processor, causes the processor to implement the data configuration method above.

In some other embodiments of the present disclosure, an electronic device is provided. The electronic device can include one or more processors and one or more memories.

The one or more memories can store an application program and the data generated when the application program runs that, when executed by the one or more processors, cause the one or more processors to implement the data configuration method above.

The data configuration method can include monitoring the target segment of the VF supporting the RDMA communication mode, when a change event is detected in the target segment of the VF, and synchronizing the configuration data of the namespace represented by the target segment to the configuration information of the container resources in the first communication mode and the second communication mode. The target segment can be set in the configuration space of the VF and can be used to represent the identification information of the independence space of the container assigned to the VF.

In some embodiments, the method can further include configuring the VF of the PF of the host, setting the target segment of the VF when determining that the PF supports the RDMA, and setting the initial value.

In some embodiments, the method can further include obtaining the configuration information of the independence space corresponding to the container when the target container application assigns the VF to the container, and modifying the initial value of the target segment of the VF to the current value based on the configuration information of the independence space.

In some embodiments, the change event of the target segment of the VF can include that the initial value of the target segment of the VF is changed to the current value.

The method can further include, if the namespace corresponding to the container is detected to change, updating the configuration information of the independent namespace, updating the current value of the target segment of the VF based on the updated configuration information of the independent namespace, and updating the target segment based on the updated current value of the target segment.

In some embodiments, the first communication mode can include the Ethernet communication mode. The second communication mode can include the RDMA communication mode. Synchronizing the configuration data of the namespace represented by the target segment to the configuration information of the container resources in the first communication mode and the second communication mode can include synchronizing the configuration ndata of the namespace represented by the target segment to the kernel protocol stack corresponding to the Ethernet communication mode and the RDMA protocol stack corresponding to the RDMA communication mode. The container application platform can perform the data transmission in the Ethernet communication mode based on the configuration information of the kernel protocol stack. The container application platform can perform the data transmission in the RDMA communication mode based on the configuration information of the RDMA protocol stack.

In some embodiments, the method can further include, if the container application platform generates the resource calling request, parsing the resource calling request to determine the target communication mode corresponding to the resource calling request, obtaining the target container resource information corresponding to the target communication mode based on the independent namespace corresponding to the target communication mode, and responding to the resource calling request based on the target container resource information.

For the implementation of the processor, reference can be made to the related content above, which is not repeated here.

Embodiments of the present disclosure are described in a progressive manner. Each embodiment focuses on differences from other embodiments. Similar parts between the embodiments can be referred to each other. For the apparatus disclosed in embodiments of the present disclosure, since the apparatus corresponds to the method above, the description is relatively simple. For relevant parts, reference can be made to the description of the method embodiments.

Those skilled in the art can further realize that the units and algorithm steps of the examples described in conjunction with embodiments of the present disclosure can be implemented by electronic hardware, computer software, or a combination thereof. To clearly illustrate the interchangeability of hardware and software, the structures and steps of each example have been generally described in terms of function in the foregoing description. Whether these functions are performed by hardware or software depends on the specific application and design constraints of the technical solution. Those skilled in the art may use different methods to implement the described functions for each specific application. However, such implementation should not be considered beyond the scope of the present disclosure.

The method or algorithm steps described in conjunction with embodiments of the present disclosure can be implemented directly by hardware, a software module executed by a processor, or a combination thereof. The software module may be arranged in random access memory (RAM), memory, read-only memory (ROM), electrically programmable ROM, electrically erasable programmable ROM, registers, hard disks, removable disks, CD-ROMs, or any other known form of storage medium.

The foregoing description of the disclosed embodiments enables those skilled in the art to implement or use the present disclosure. Various modifications to these embodiments are obvious to those skilled in the art. The general principles defined herein may be implemented in other embodiments without departing from the spirit or scope of the present disclosure. Therefore. the present disclosure is limited to the embodiments shown herein but shall conform to the widest scope consistent with the principles and novel features of the present disclosure.

What is claimed is:

1. A data configuration method comprising:
monitoring a target segment of a virtual network interface card (VF) capable of implementing a remote direct memory access (RDMA) communication mode; and
in response to detecting a change event in the target segment of the VF, synchronizing configuration data of a namespace represented by the target segment to configuration information of a container resource in a first communication mode and a second communication mode;
wherein the target segment is set in a configuration space of the VF and is used to represent identification information of an independent namespace assigned to the VF in a container.

2. The method according to claim 1, further comprising:
configuring the VF based on a physical network interface card (PF) of a host;
setting the target segment of the VF when determining that the PF supports RDMA; and
assigning an initial value to the target segment.

3. The method according to claim 2, further comprising:
in response to a target container application assigning the VF to the container, obtaining configuration information of the independent namespace corresponding to the container; and
modifying the initial value of the target segment of the VF to a current value based on the configuration information of the independent namespace.

4. The method according to claim 3,
wherein the change event in the target segment of the VF includes that the initial value of the target segment of the VF is changed to the current value;
the method further comprising:
in response to detecting a change in the namespace corresponding to the container, updating the configuration information of the independent namespace;
updating the current value of the target segment of the VF based on the updated configuration information of the independent namespace; and
updating the target segment based on the updated current value of the target segment.

5. The method according to claim 1, wherein the first communication mode includes an Ethernet communication mode, the second communication mode includes an RDMA communication mode, and synchronizing the configuration data of the namespace represented by the target segment to the configuration information of the container resource in the first communication mode and the second communication mode includes:
synchronizing the configuration data of the namespace represented by the target segment to a kernel protocol stack corresponding to the Ethernet communication mode and an RDMA protocol stack corresponding to the RDMA communication mode;
wherein a container application platform performs data transmission in the Ethernet communication mode based on configuration information of the kernel protocol stack, and the container application platform performs data transmission in the RDMA communication mode based on configuration information of the RDMA protocol stack.

6. The method according to claim 5, further comprising:
in response to the container application platform generating a resource calling request, parsing the resource calling request to determine a target communication mode corresponding to the resource calling request;
obtaining target container resource information corresponding to the target communication mode based on an independent namespace corresponding to the target communication mode; and
responding to the resource calling request based on the target container resource information.

7. A data configuration apparatus, comprising:
a monitoring unit configured to monitor a target segment of a virtual network interface card (VF) capable of implementing a remote direct memory access (RDMA) communication mode; and
a synchronization unit configured to, in response to detecting a change event in the target segment of the VF, synchronize configuration data of a namespace represented by the target segment to configuration information of a container resource in a first communication mode and a second communication mode;
wherein the target segment is set in a configuration space of the VF and is used to represent identification information of an independent namespace assigned to the VF in a container.

8. The data configuration apparatus according to claim 7, further comprising a setting unit, configured to:
configure the VF based on a physical network interface card (PF) of a host;
set the target segment of the VF when determining that the PF supports RDMA; and
assign an initial value to the target segment.

9. The data configuration apparatus according to claim 8, further comprising:
a first acquisition unit configured to, in response to a target container application assigning the VF to the container, obtain configuration information of the independent namespace corresponding to the container; and
a modification unit configured to modify the initial value of the target segment of the VF to a current value based on the configuration information of the independent namespace.

10. The data configuration apparatus according to claim 9,
wherein the change event in the target segment of the VF includes that the initial value of the target segment of the VF is changed to the current value;
the data configuration apparatus further comprising:
a first update unit configured to, in response to detecting a change in the namespace corresponding to the container, update the configuration information of the independent namespace;
a second update unit configured to update the current value of the target segment of the VF based on the updated configuration information of the independent namespace; and
a third update unit configured to update the target segment based on the updated current value of the target segment.

11. The data configuration apparatus according to claim 7, wherein the first communication mode includes an Ethernet communication mode, the second communication mode includes an RDMA communication mode, and the synchronization unit is further configured to:
synchronize the configuration data of the namespace represented by the target segment to a kernel protocol stack corresponding to the Ethernet communication mode and an RDMA protocol stack corresponding to the RDMA communication mode;
wherein a container application platform performs data transmission in the Ethernet communication mode based on configuration information of the kernel protocol stack, and the container application platform performs data transmission in the RDMA communication mode based on configuration information of the RDMA protocol stack.

12. The data configuration apparatus according to claim 11, further comprising:
a parse unit configured to, in response to the container application platform generating a resource calling request, parse the resource calling request to determine a target communication mode corresponding to the resource calling request;
a second acquisition unit configured to obtain target container resource information corresponding to the target communication mode based on an independent namespace corresponding to the target communication mode; and
a respond unit configured to respond to the resource calling request based on the target container resource information.

13. An electronic device comprising:
one or more processors; and
one or more memories storing an application and data generated by the application during operation that, when executed by the one or more processors, cause the one or more processors to:
monitor a target segment of a virtual network interface card (VF) capable of implementing a remote direct memory access (RDMA) communication mode; and
in response to detecting a change event in the target segment of the VF, synchronize configuration data of a namespace represented by the target segment to configuration information of a container resource in a first communication mode and a second communication mode;
wherein the target segment is set in a configuration space of the VF and is used to represent identification information of an independent namespace assigned to the VF in a container.

14. The device according to claim 13, wherein the one or more processors are further configured to:
configure the VF based on a physical network interface card (PF) of a host;
set the target segment of the VF when determining that the PF supports RDMA; and
assign an initial value to the target segment.

15. The device according to claim 14, wherein the one or more processors are further configured to:
in response to a target container application assigning the VF to the container, obtain configuration information of the independent namespace corresponding to the container; and
modify the initial value of the target segment of the VF to a current value based on the configuration information of the independent namespace.

16. The device according to claim 15, wherein:
the change event in the target segment of the VF includes that the initial value of the target segment of the VF is changed to the current value; and
the one or more processors are further configured to:
in response to detecting a change in the namespace corresponding to the container, update the configuration information of the independent namespace;
update the current value of the target segment of the VF based on the updated configuration information of the independent namespace; and
update the target segment based on the updated current value of the target segment.

17. The device according to claim 13, wherein the first communication mode includes an Ethernet communication mode, the second communication mode includes an RDMA communication mode, and the one or more processors are further configured to:
synchronize the configuration data of the namespace represented by the target segment to a kernel protocol stack corresponding to the Ethernet communication mode and an RDMA protocol stack corresponding to the RDMA communication mode;
wherein a container application platform performs data transmission in the Ethernet communication mode based on configuration information of the kernel protocol stack, and the container application platform performs data transmission in the RDMA communication mode based on configuration information of the RDMA protocol stack.

18. The device according to claim 17, wherein the one or more processors are further configured to:
in response to the container application platform generating a resource calling request, parse the resource calling request to determine a target communication mode corresponding to the resource calling request;
obtain target container resource information corresponding to the target communication mode based on an independent namespace corresponding to the target communication mode; and
respond to the resource calling request based on the target container resource information.
